(19) United States
(12) Patent Application Publication
(10) Pub. No.: US 2009/0230704 A1
(43) Pub. Date: Sep. 17, 2009

(54) Closure retention and release mechanisms

(75) Inventors: Nicholas Roger Charles Goddard, County Durham (GB); Sarah Louise Jackson, Northumberland (GB)

Correspondence Address: DOWNS RACHLIN MARTIN PLLC, 199 MAIN STREET, P O BOX 190, BURLINGTON, VT, 05402-0190, US

(73) Assignee: Stephenson Gobin Limited, County Durham (GB)

(21) Appl. No.: 11/665,081

(22) PCT Filed: Oct. 11, 2005
(86) PCT No.: PCT/GB2005/003893

§ 371 Date: Oct. 24, 2008

(30) Foreign Application Priority Data
Oct. 11, 2004 (GB) 0422566.0

(51) Int. Cl. E05C 19/16

(52) U.S. Cl. 292/251.5

(57) ABSTRACT

A closure retention and release mechanism (14) comprises a body (22) having spaced apart first and second portions (28, 30) of ferrous material, a magnet (24) having north and south poles (40,42) mounted between said portions (28, 30) and actuation means operable to move the magnet (24) relative to said portions (28, 30), wherein the magnet (24) is movable between a first position where each pole (40, 42) of the magnet (24) is located fully in a respective portion (28, 30) of the body (22) and a second position where each pole (40, 42) is not located fully in a respective portion (28, 30) of the body (22).

The present invention relates to a closure retention and release mechanism and in particular, though not exclusively, to a door holder for a fire door. A system for the control and operation of a closure holder is also described.

Fire doors are installed in buildings to prevent the spread of smoke and fire through the building in the event of a fire. In order to serve their purpose the doors must be closed, however this may be inconvenient during periods when the building is occupied, for example an office building, or times when there is significant movement of people within the building, for example hospital, nursing home or hotel building during periods when the occupants are awake. A common solution involves the use door holder devices which are operable to maintain the fire doors in an open state but are arranged to release the doors in the event of a fire alarm being raised. The doors thus released are able to close under the influence of a separate or integrated closing mechanisms. In such a system the door holders are typically required to be hard wired to the fire alarm system.

Numerous forms of door holder mechanisms presently exist. The most common system includes an electromagnet mounted on the floor, ceiling, or wall adjacent a fire door, and a ferrous plate mounted on the door. The plate, and hence the door, will remain held by the magnet for as long as it is energised. The door is released when the power supply to the electromagnet is cut. A similar system incorporates the combination of a permanent magnet and an electromagnet. The door is retained by the permanent magnet until the electromagnet is energised. The electromagnet is arranged to oppose the filed of the permanent magnet and thereby cause the door to be released.

Known door closing mechanisms may include a spring and a hydraulic damper, the hydraulic damper being arranged to control the closing speed of the door. In such an instance a door holder mechanism may be incorporated into the hydraulic damper to block the flow of fluid therethrough and thereby maintain the door in an opened state.

According to the first aspect of the present invention there is provided a closure retention and release mechanism comprising a body having spaced apart first and second portions of a ferrous material, a magnet having north and south poles mounted between said portions and actuation means operable to move the magnet relative to said portions, wherein the magnet is movable between a first position where each pole of the magnet is located in a respective portion of the body and a second position where each pole is not located in a respective portion of the body. In one embodiment the second position of the magnet may correspond to a position where each pole of the magnet is located equally in both portions of the body. Alternatively the second position of the magnet may correspond to a position whereupon the magnet is moved away and is spaced from the body.

In the first position of the magnet relative to the body portions the magnet is able to act through the body portions to attract and retain an engagement plate of a closure, such as a door. In the second position of the magnet relative to the body portions the magnet is unable to act through the body portions, either as a result of its orientation relative to and/or spacing from the body portions, and hence is unable to attract and retain an engagement plate.

The body portions may be spaced from one another by the provision of a non-ferrous spacer positioned therebetween. In an alternative embodiment an air space may be provided between the body portions. In such an embodiment the body portions may be supported in a holder or frame work which maintains the spacing between the blocks. Preferably the body is provided with an engagement face which, in use, is adapted to interface with a portion of a closure. The engagement face may be provided in an extension of one of the body portions. Preferably both body portions may include an extension, with the engagement face being provided partially upon each extension.

Preferably the magnet is located in a recess defined between the body portions. The recess may preferably be a through hole of the body. In such an embodiment the magnet may be substantially cylindrical and mounted for rotation in the through hole.

Rotation of the magnet may preferably be effected by the provision of a motor arranged to drive a rotation mechanism. The rotation mechanism may comprise a gear train arranged between an output of the motor and the magnet. The gear train may comprise a worm gear connected to an output shaft of the motor, an drive gear connected to the magnet and a reduction gear provided intermediate the worm and drive gears. The gear train may include one or more additional gears.

The motor may be reversible so as to permit the magnet to be rotated both clockwise and anticlockwise. Alternatively the motor may operate in a unidirectional manner so as to rotate the magnet in a unidirectional manner. In both embodiment the motor includes a control system operable to ascertain the position of the magnet relative to the body and to cease the operation of the motor when the magnet reaches a desired position. The control system may include one or more limit switches.

In an alternative embodiment the magnet may be movable in a linear manner relative to the body. In such an embodiment the mechanism includes a motor and a reciprocating motion mechanism arranged to move the magnet between the first and second positions.

In an alternative embodiment the actuation means may include an actuation member contactable by a closure. The actuation member may be movable between a first position corresponding to the first position of the magnet relative to the body portions, and a second position corresponding to the second position of the magnet relative to the body portions. Preferably the movement of the actuation member from the first position to the second position is resisted a resilient member such as, for example, a hairpin spring. The actuation member may be movable linearly between said first and second positions.

The actuation means may also include a drive member coupled to the magnet, the drive member being arranged to transmit movement of the actuation member to the magnet. The drive member may be coupled to the magnet via an intermediate member. The drive member is movable between a first position corresponding to the first position of the magnet relative to the body portions, and a second position corresponding to the second position of the magnet relative to the body portions. Movement of the drive member from the first position to the second position may be resisted a resilient member. In a preferred embodiment the drive member is rotatable between said first and second positions.

The actuation means may includes a latch arrangement operable to releasably retain the drive member in the second position. The latch arrangement may include a latch arm and a latch arm actuator.

According to a second aspect of the present invention there is provided a method of controlling a closure retention and release mechanism the method comprising the steps of:
providing a master controller having a transmitter;
providing a slave unit having a receiver;
providing a closure retention and release mechanism associated with the slave unit, the slave unit being operable to switch the closure retention and release mechanism between closure retention and release states;
transmitting a control signal from the master controller to the slave unit; wherein the slave unit is operable to switch the state of the closure retention and release mechanism in the absence of receiving the control signal from the master controller.

In one embodiment the control signal may comprise a repetitive signal. The signal may comprise a series of pulses. The slave unit may be operable to switch the state of the closure retention and release mechanism in the absence of receiving one or more pulses of the control signal.

The slave unit is preferably switchable between an active state and an inactive state. In the active state the slave unit is configured so as to receive the control signal. In the inactive state the slave unit is not able to receive the control signal. Switching of the slave unit from the active state to the inactive state is preferably triggered by receipt of the control signal by the slave unit. Switching of the slave unit subsequently back to the active state occurs after a predetermined time period has elapsed after the slave unit has entered the inactive state. The predetermined time period is synchronised with the period of the control signal pulses.

The slave unit may act to switch the state of the closure retention and release mechanism in response to the absence of receiving a single pulse of the control signal. In an alternative embodiment the slave unit may act to switch the state of the closure retention and release mechanism after failing to receive a plurality of pulses of the control signal. In such an embodiment the slave unit may enter an alert state after failing to receive a first pulse of the control signal whereupon the slave unit remains in the active state in anticipation of receiving a subsequent pulse of the control signal. If a pulse of the control signal is subsequently received within a predetermined time period then the slave unit reenters the inactive state. If a pulse of the control signal is not received within a predetermined time period then the slave unit acts to switch the state of the closure retention and release mechanism. The predetermined time period during which the slave unit remains in the alert state preferably corresponds to a multiple of the time period between the scheduled pulses of the control signal.

The method may include the additional step of;
incorporating a command into the control signal, the command prompting the slave unit to switch the state of the closure retention and release mechanism.

The method may include the additional steps of;
providing the slave unit with a transmitter;
providing the master controller with a receiver;
incorporating an interrogation command into the control signal;
sending the interrogation command to the slave unit to prompt the slave unit to respond to the master controller.

According to a third aspect of the present invention there is provided a control system for a closure retention and release mechanism, the control system comprising a master controller having a transmitter, a slave unit having a receiver, and a closure retention and release mechanism associated with the controller, the slave unit being operable to switch the closure retention and release mechanism between closure retention ad release states in the absence of receiving a control signal from the master controller. Optionally the slave unit may be provided with a transmitter and the master controller with a receiver to enable the slave unit to correspond with the master controller.

Embodiments of the present invention will now be described with reference to the accompanying drawings in which:

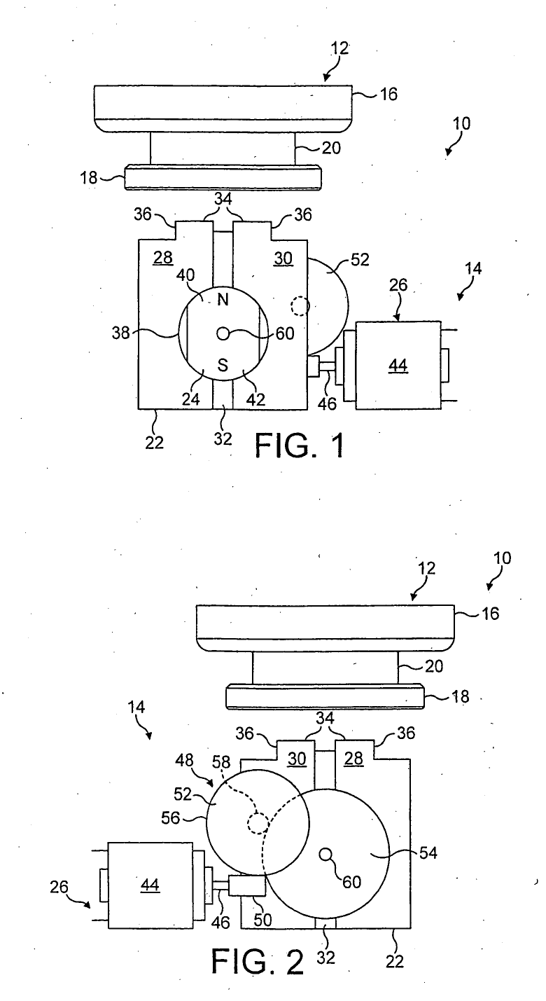

FIG. 1 is a side view of a mechanism according to a first embodiment the present invention;

FIG. 2 is a further side view of the mechanism;

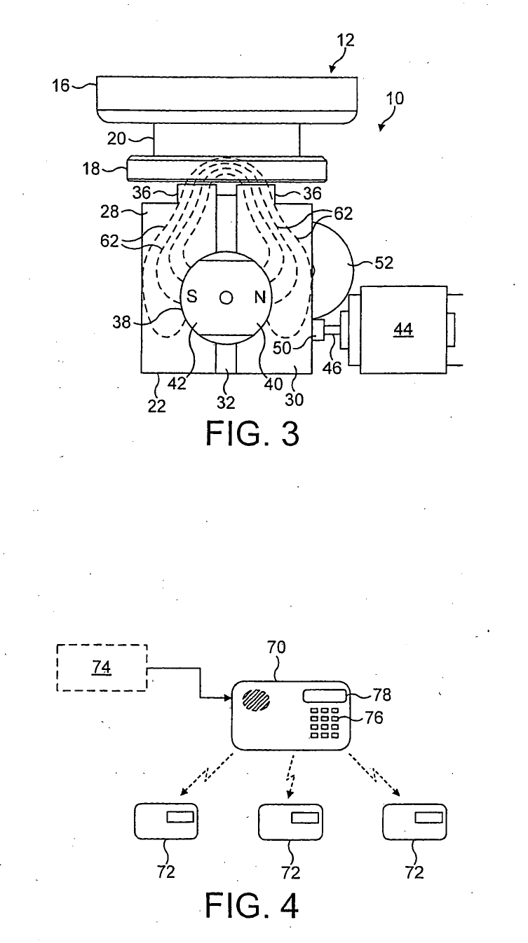

FIG. 3 is an other side view of the mechanism;

FIG. 4 is a schematic view of a control system according to an embodiment of the present invention;

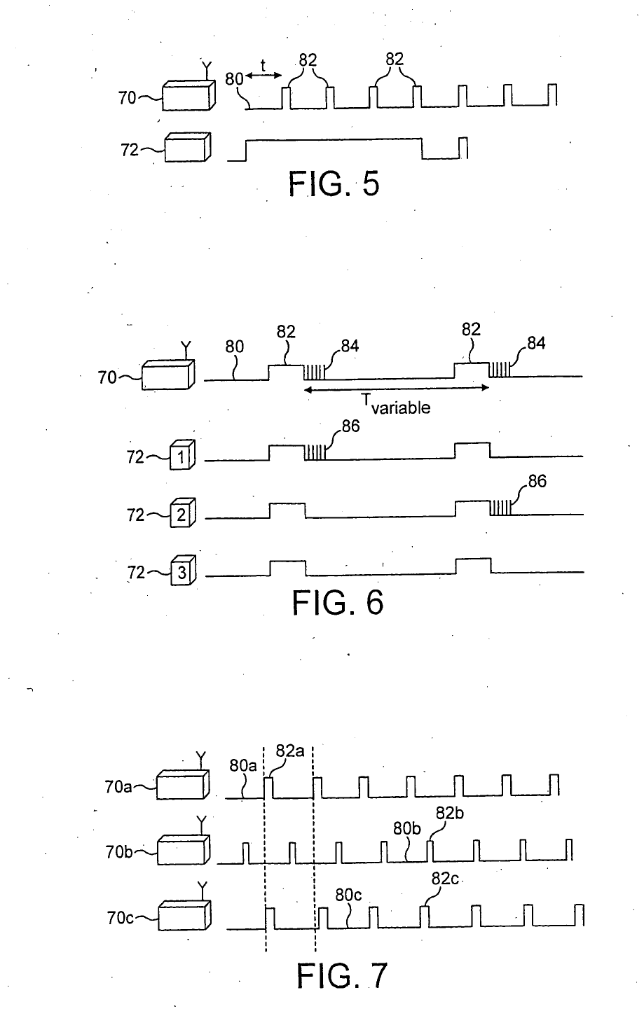

FIG. 5 is a schematic representation of the interaction between a controller and an actuator of the system;

FIG. 6 is a schematic representation of the interaction between a controller and multiple actuators of the system;

FIG. 7 is a schematic representation of the interaction between multiple controllers;

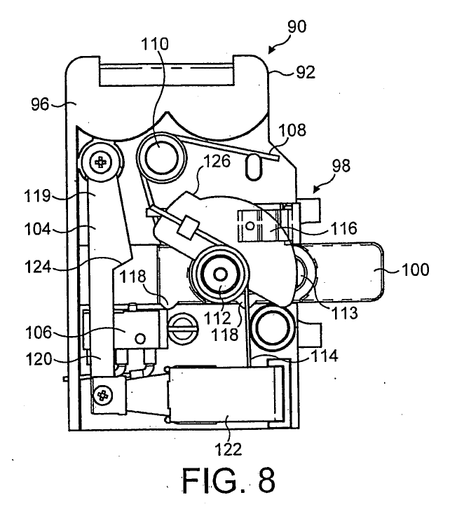

FIG. 8 is a side view of a mechanism according to a further embodiment of the present invention;

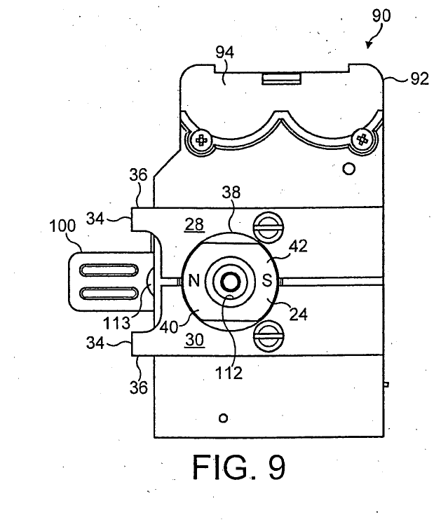

FIG. 9 is a side view of the other side of the mechanism of FIG. 8;

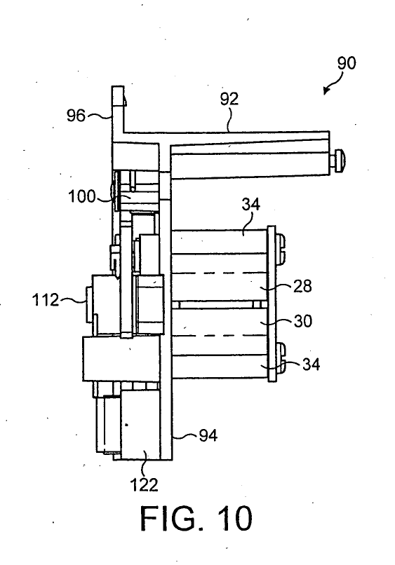

FIG. 10 is an end view of the mechanism of FIG. 8;

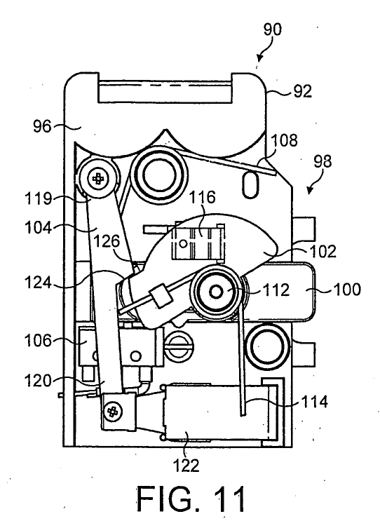

FIG. 11 is a side view of the mechanism of FIG. 8; and

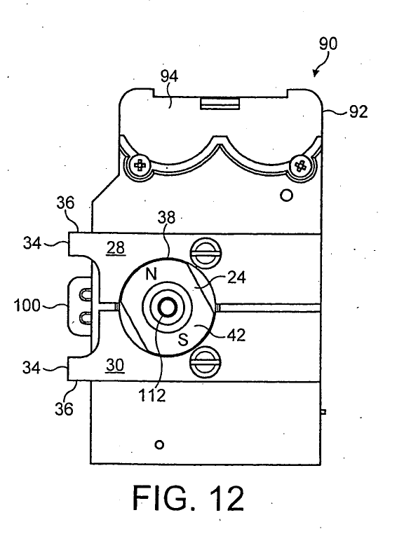

FIG. 12 is a side view of the other side of the mechanism of FIG. 8.

Referring firstly to FIGS. 1 to 3 there is shown a closure holding device generally designated 10. The device comprises a plate 12 and a magnetic retention/release mechanism 14. The plate 12 is attachable to a door by any appropriate means such as, for example screws or like fasteners. The plate 12 comprises a base 16, an engagement face portion 18 and a flexible neck 20 connecting the base 16 to the face portion 18.

The flexibility of the neck 20 ensures that minor misalignment between the plate 12 and mechanism 14 can be accommodated. The face portion 16 of the plate 12 at least is comprised of a ferrous metal such as steel. The ferrous metal may be provided in an insert mounted to the face portion 16. Alternatively the plate 12 in its entirety may be comprised of a ferrous metal.

The mechanism 14 comprises body 22, a permanent magnet 24 and an actuation mechanism 26. The body 22 is comprised of two blocks 28,30 of ferrous metal such as, for example, steel. The blocks 28,30 sandwich, and hence are separated by, a member 32 comprised of a non-magnetic material such as, for example, aluminium alloy. In an alternative embodiment the blocks 28,30 may be mounted relative to one another such that an air gap instead of the non-magnetic material is provided therebetween. In such an embodiment the blocks 28,30 may be mounted in a non-magnetic holder The blocks 28,30 include an engagement face 34. In the embodiment shown the engagement face 34 is provided on a projection 36 of each block 28 either side of the non-magnetic member 32.

The permanent magnet 24 is positioned in a through hole 38 provided in the blocks 28,30 and non-magnetic member 32. The through hole 38 is positioned such that equal portions thereof are provided in each block 28,30. The magnet 24 has both north and south poles 40,42 and is rotatable in the through hole between a first position where the poles 40,42 are aligned with the non-magnetic member 32 (FIG. 1) and a second position where the poles 40,42 are aligned transverse to the 32 such that each pole 40,42 is positioned in a respective block 28,30 (FIG. 3).

The release/retention mechanism 14 comprises a motor 44 having a drive shaft 46 and a gear arrangement 48. The gear arrangement 48 comprises a worm gear 50 mounted on the drive shaft 46, a reduction gear 52 and a drive gear 54. The reduction gear 52 comprises a large diameter portion 56 and a concentric smaller diameter portion 58. The periphery of each portion 56,58 is toothed such that the portions 56,58 mate respectively with the worm gear 50 and drive gear 54. The drive gear 54 is connected to the permanent magnet 24 via a spindle 60. It will thus be understood that operation of the motor 44 causes the drive shaft 46 and worm gear 50 to rotate. Rotation of the worm gear 50 causes the reduction gear 52 to rotate which in turn causes the drive gear 54 to rotate. Rotation of the drive gear results in rotation of the magnet 24 within the through hole 38. The arrangement of the gears 50,52,54 is such that the rotational speed of the drive gear 54 is less than that of the drive shaft/worm gear 46,50, while the torque applied to the permanent magnet 24 is greater than that applied to the drive shaft 46 by the motor 26. The embodiment shown in FIGS. 1 to 3 the gear arrangement includes a single reduction gear 52. It will be appreciated that one or more additional gears may be incorporated in the gear train between the drive shaft 46 and drive gear 54 to achieve the desired rotation characteristics for the magnet 24.

The motor 26 may be reversible so as to permit the magnet 24 to rotated both clockwise and counter-clockwise. Alternatively the motor 26 may rotate in a unidirectional manner. In such an embodiment the motor 26 will include appropriately configured limit switches to halt the rotation of the magnet 24 substantially every 90 degrees.

Operation of the device 10 will now be described. During normal operation the magnet 24 is aligned with the blocks 28,30 as shown in FIG. 3. The position of the magnet 24 in FIG. 3 may be referred to as the retention position. As described above the poles 40,42 of the magnet 24 are each positioned in a respective block 28,30. As such, each block 28,30 effectively becomes an extension of the respective pole 40,42 with the result that magnetic lines of force, indicated by broken lines 62, extend from the north pole 40 to the south pole 42. The magnet 24 and block 28,30 arrangement is thus able to attach ferrous metal, such as the plate 12 thereto. As described above the plate 12 is connected to a closure such as a door, while the release mechanism 14 is mounted to a wall behind the closure. The strength of the magnet 24 is such that the plate 12 and closure is held securely thereto. The strength of the magnet 24 is selected such that the attractive force experienced by the plate 12 is greater than any force applied to the door by a spring biased or hydraulic closing mechanism.

Typically the strength of the magnet 24 may be chosen such that attractive force applied to the plate is greater than any externally applied forces, such as for example wind loading, which may reasonably be expected to experienced by the closure. As a safety precaution however, the strength of the magnet 24 may be such that the attractive force experienced by the plate 12 may be overcome in the event of an emergency by a person applying sufficient force to the closure

In the event that it is desired to separate the plate 12 from the mechanism 14 in a controlled manner the motor 26 can be operated to rotate the magnet 24 through substantially 90 degrees to the position shown in FIG. 1. The position of the magnet 24 in FIG. 1 may be referred to as the release position. With, the magnet 24 in this position both of the poles 40,42 provided partially in each block 28,30 and as such the magnetic lines of force are fully contained within the blocks 28 30. The magnet 24 is therefore unable to attract ferrous metal at or near the external faces of the blocks 28,30. The mechanism 14 is thus unable to retain the plate 12 and closure to which the plate 12 is attached. The closure is thus able to be closed either manually or more preferably under the influence of a closing mechanism associated with the closure. When it is desired to reactivate the mechanism 14, the motor 26 may be operated to rotate the magnet to the position shown in FIG. 3. This may be achieved either by reversing the motor 26 or continuing the rotation of the motor 26 in the same direction as before.

The mechanism 14 is preferably integrated into a control system which controls the operation of the motor 26. For example the control system may be configured to move the magnet 24 at predetermined time intervals. Such a system may be particularly useful in a building which is substantially unoccupied during the night. In such a circumstance the control system may be configured to move the magnet 24 to the release position at a predetermined time of the evening to enable a closure to close. At a predetermined time of the morning the magnet 24 may be moved to the retention position ready to retain the closure when it is opened for the first time. The control system is preferably also able to move the magnet 24 to the release position in the event of an emergency such as a fire alarm being raised.

Referring now to FIGS. 8 to 12 there is shown an alternative embodiment of a magnetic retention/release mechanism generally designated 90. Features common to the embodiment described with reference to FIGS. 1 to 3 are identified with like reference numerals. The mechanism 90 of FIGS. 8 to 12 differs from the mechanism 14 of FIGS. 1 to 3 in that the motor 44 and gear arrangement 48 are replaced by spring operated arrangement for the movement of the permanent magnet 24.

The mechanism 90 includes a mounting plate 92 which has mounted on one side 94 the magnet 24 and the blocks of ferromagnetic material 28, 30, and on the other side 96 an actuation mechanism generally designated 98. The actuation mechanism 98 includes a slider bar 100, a latch wheel 102, a latch lever 104 and a micro switch 106. The slider bar 100 is movable between an extended position shown in FIGS. 8 and 9, and a retracted position shown in FIGS. 11 and 12. The bar 100 is movable from the extended position to the retracted position against a spring 108 which provides a restorative force urging the bar 100 towards the extended position. The spring 108 is mounted to a projection 110 of the mounting plate 92.

The latch wheel 102 is connected to a shaft 112 which extends through an aperture of the mounting plate 92. The shaft 112 is connected to the magnet 24 such that rotation of the latch wheel 102 results in rotation of the magnet 24 relative to the blocks 28,30. The latch wheel 102 is rotatable between a release position, shown in FIG. 8 and a retention position shown in FIG. 11. The latch wheel 102 is movable from the release position to the retention position against a spring 114 which provides a restorative force urging the latch wheel 102 to the release position. The spring 114 is mounted about the shaft 112. A ratchet pawl 116 is provided between the slider bar 100 and the latch wheel 102 such that movement of the slider bar 100 from the extended position to the retracted position results in rotational movement of the latch wheel 102 from the release position to the retention position. The shaft 112 extends through an elongate slot 113 of the slider bar 100.

The slider bar 100 is provided with a projection 118 which, in use, interact with the microswitch 106. The microswitch 106 is positioned such that movement of the slider bar 100 between the extended and retracted positions causes the projection to contact, and hence operate, the microswitch 106. The position of the projection is such that the microswitch is activated towards the end of the slider bar travel in the direction from the extended to the retracted position.

The latch lever 104 is pivotable connected at one end 119 to the mounting plate 92. The opposing end 120 of the latch lever 104 is connected to a solenoid 122. The solenoid is operable to move the latch lever 104 between a latching position, shown in FIG. 11, and a release position shown in FIG. 8. The latch lever 104 is provided with a pawl 124 which, in the latching position, engages a latch surface 126 of the latch wheel 102. It will be understood that when the latch lever 104 is in the latching position, and the pawl 124 is engaged with the latch surface 126, the latch wheel 102 is retained in the retention position.

Operation of the mechanism 90 will now be described. The mechanism 90 is initially in the configuration shown in FIGS. 8 and 9, which is to say the slider bar 100 is in the extended position, the latch wheel 102 in the release position, and the latch lever 104 in the release position. The magnet 24 is positioned such that each pole 40,42 thereof is aligned partially within each block 28, 30. As a metal plate of a door (both not shown) is moved towards the mechanism 90, the plate contacts the slider bar 100 and thereby causes the slider bar to commence movement from the extended to the retracted position. This movement causes the latch wheel 102 to commence rotation from the release position to the retention position. The movement of the slider bar 100 further activates the micro switch 106 with a first projection 118 thereof.

The microswitch 106 corresponds with a controller to indicate that the door associated with the mechanism 90 is approaching an open condition. Should the controller determine that it is safe to hold the door open, a command is send to the latch lever solenoid 122 to move from the release position to the latch position and thereby hold the latch wheel 102. This arrangement can be readily seen in FIG. 11. With the latch wheel 102 in the retention position the poles 40,42 of the magnet 24 are each disposed fully within separate blocks 28,30. The blocks 28,30 are thus magnetized and hence the plate, and the door associated therewith, are retained by the mechanism 90. When it is required to close the door, the controller sends an appropriate signal to the solenoid 122 to cause the latch lever 104 to move to the release position. The latch wheel 102 is thus able to return to the release position under the influence of the spring 114. The poles 40,42 of the magnet are moved back to the position shown in FIG. 9 and the blocks 28,30 are demagnetized. As the door plate moves away from the mechanism 90 the slider bar 100 is able to return to the extended position under the influence of the spring 108.

According to a further aspect of the invention there is provided a control system for one or more closure mechanisms which will now be described with reference to FIGS. 4 to 7. The system may be utilised with devices 10 of the type described above or with other know types of closure retention devices.

Referring firstly to FIG. 4 there is shown a schematic representation of a control system. The control system comprises a master controller 70 which is in wireless communication with a plurality of slave units 72. Three slave units 72 are shown for the sake of simplicity, however it will be understood that the system may operate with a greater or lesser number of slave units 72. The master controller 70 is connected to a fire alarm control system 74. The master controller 72 may be connected to the fire alarm control system via a hardwired connection or a wireless link. The slave units 72 are each connected to a closure retention and release mechanism which in turn is used to hold a fire door in an open position. The slave units 72 are connected to the closure retention and release mechanisms via a hardwired link.

The master controller 70 includes a transmitter operable to send information to the slave units 72 and a receiver operable to receive information transmitted by the slave units 72. The master controller 70 is further provided with a keypad interface 76 and a display 78. Each of the slave units 72 includes a transmitter operable to send information to the master controllers 70 and a receiver operable to receive information transmitted by the master controller 70. Each slave unit 72 further includes means to operate the closure retention and release mechanism with which it is associated. Taking the example of the device 10 described with reference to FIGS. 1 to 3, the means may comprise a power source such as a battery for the motor 26 and a switching means operable to selectively connect the power source to the motor 26.

In use, the master controller 70 emits a periodic control signal 80 which is intended to be received by the slave units 72. As illustrated in FIG. 5 the signal 80 comprises a plurality of equally spaced pulses 82. Upon initial start up of a slave unit 72, the slave unit 72 “listens” for a predetermined number of repetitions of the control signal 80. In doing so the slave unit 72 is able to determine the average time t between each pulse. Once the period t has been determined, the slave unit 72 enters a hibernation mode whereupon it alternates between an active state whereupon it is awake and able to receive the control signal 80 and an inactive state whereupon it is not able to receive the control signal 80. The switching of the slave unit 72 from the inactive to the active state is synchronised with the period t of the control signal 80. Thus the slave unit 72 enters the active state shortly before it expects to receive a pulse 82 of the control signal 80. Upon receiving the control signal 80 the slave unit 72 re-enters the inactive state. During this normal mode of operation wherein the slave unit 72 cycles between the active and inactive states, the closure retention and release mechanism associated with the slave unit 72 remains in its original operational state holding the fire door open.

In the embodiment illustrated in FIG. 5 the slave unit 72 is set up to monitor four repetitions of the control signal 80 in order to determine the period t. It will be appreciated that the slave unit 72 may be set up to monitor a greater or lesser number of control signal 80 repetitions in order to determine the period t.

In the event that the slave unit 72 does not receive a pulse 82 of the control signal 80 as expected, then the slave unit 72 enters an alert state whereupon it remains active and awaits the next scheduled pulse 82 of the control signal 80. If the next scheduled pulse 82 is received then the slave unit 72 reverts to cycling between the active and inactive states as described above. In the event that a predefined number of pulses 82 are not received by the slave unit 72, then the slave unit 72 acts to change the operative state of the closure retention and release mechanism to which it is connected. In an alternative embodiment the slave unit 72 may be arranged such that it acts to change the operative state of the closure retention and release mechanism if a single pulse 82 of the control signal 80 is not received. It will be understood that in such an embodiment the slave unit 72 does not enter the alert state described above.

In the event of a fire alarm being raised the master controller 70 may be instructed by the fire alarm control system 74 to close the fire doors retained in an open state by the retention and release mechanisms. In such a circumstance the master controller 70 stops transmitting the control signal 80 thereby promoting the slave units 72 to change the operative state of the retention and release mechanisms. It will be appreciated that the control signal may be stopped in alternative circumstances. For example, the control signal 80 may be stopped in the event of a power failure at either the master controller 70 or the fire alarm control system 74. In such an event the fire doors are permitted to close as a precaution. In yet an alternative embodiment the control signal 80 may be stopped at a predetermined time of the day, for example after working hours, to permit closure of the fire doors.

Referring now to FIG. 6 there is illustrated a slave unit interrogation protocol. In order to check the status of the slave units 72 the master controller 70 may send with a pulse 82 of the control signal 80 an interrogation command 84 for a particular slave unit 72. The interrogation command 84 may, for example, instruct a slave unit 72 to confirm that it is still active and advise on the status of an internal power source used to change the state of an associated retention and release mechanism. Upon receiving the interrogation command 84 the slave unit 72 sends an appropriate response 86 which is received by the master controller 70. In the event that no response is received, or a response is received which indicates that the slave unit 72 requires attention, the master controller 70 may act to draw this to the attention of a person responsible for the maintenance of the system. In addition or as an alternative to the interrogation command 84 a pulse 82 of the control signal 80 may also include a command to the slave unit 72 to change the state of the closure retention and release mechanism.

There may exist circumstances where a building may require more than one master controller 70. Such a circumstance may arise where the building has multiple floors and it is desired to control the fire doors of each floor independently. Each floor may therefore be provided with a separate master controller 70a,70b,70c as illustrated in FIG. 7. So as to prevent the control signals 80a,80b,80c from each controller 70a,70b,70c being received by slave units not on the same floor as the master controller, the control signals 80a,80b,80c are staggered as indicated in FIG. 7. As the slave units only enter the active mode shortly before they expect to receive a control signal pulse 82a,82b,82c, then the staggering of the control signals 80a,80b,80c ensures that the slave units only receive the control signal 80a,80b,80c from the controller 70a,70b,70c on the correct floor. As indicated on FIG. 6 the master controller 70 is able to vary the time period t between pulses. Where a plurality of master controllers 70a,70b,70c are provided in close proximity, then during the initial set-up of the controllers 70a,70b,70c the respective time periods t can be selected so as to ensure that the respective control signals 80a,80b,80c are not in conflict with one another.

An additional feature of the master controller 70 during the initial set-up thereof is the ability to select a frequency for the control signal which is free of interference from, for example, other radio frequency transmissions. Upon initial set-up the master controller scans a range of frequencies between upper and lower limits. The controller 70 selects a “free” frequency band and commences the broadcast of the control signal. Upon initial set-up of the slave units, they too scan the frequency range until they tune into the control signal and lock on to the frequency of transmission thereof.

1. A closure retention and release mechanism comprising a body having spaced apart first and second portions of ferrous material, a magnet having north and south poles mounted between said portions and actuation means operable to move the magnet relative to said portions, wherein the magnet is movable between a first position where each pole of the magnet is located fully in a respective portion of the body and a second position where each pole is not located fully in a respective portion of the body.

2. A mechanism according to claim 1 wherein the second position of the magnet corresponds to a position where each pole of the magnet is located partially in both portions of the body.

3. A mechanism according to claim 1 wherein the second position of the magnet corresponds to a position where each pole of the magnet is located equally in both portions of the body.

4. A mechanism according to claim 1 wherein the second position of the magnet corresponds to a position whereupon the magnet is moved away and is spaced from the body.

5. A mechanism according to claim 1 wherein the body portions are spaced from one another by the provision of a non-ferrous spacer positioned therebetween.

6. A mechanism according to claim 1 wherein the body portions are spaced from one another by the provision an air space provided between the body portions.

7. A mechanism according to claim 1 wherein the body portions are supported in a holder or frame which maintains the spacing between the blocks.

8. A mechanism according to claim 1 wherein the body is provided with an engagement face which, in use, is adapted to interface with a portion of a closure.

9. A mechanism according to claim 8 wherein the engagement face is defined by an extension of one of the body portions.

10. A mechanism according to claim 9 wherein both body portions include an extension, the engagement face being provided partially upon each extension.

11. A mechanism according to claim 1 wherein the magnet is located in a recess defined between the body portions.

12. A mechanism according to claim 11 wherein the recess is defined by a through hole of the body.

13. A mechanism according to claim 12 wherein the magnet is substantially cylindrical.

14. A mechanism according to claim 13 wherein the magnet is mounted for rotation in the through hole.

15. A mechanism according to claim 14 wherein the magnet is rotatable by the provision of a motor arranged to drive a rotation mechanism.

16. A mechanism according to claim 15 wherein the rotation mechanism includes a gear train arranged between an output of the motor and the magnet.

17. A mechanism according to claim 16 wherein the gear train includes a worm gear connected to an output shaft of the motor, a drive gear connected to the magnet and a reduction gear provided intermediate the worm and drive gears.

18. A mechanism according to claim 15 wherein the motor is reversible so as to permit the magnet to be rotated both clockwise and anticlockwise.

19. A mechanism according to claim 15 wherein the motor is operable in a unidirectional manner so as to rotate the magnet in a unidirectional manner.

20. A mechanism according to claim 15 wherein the motor includes a control system operable to ascertain the position of the magnet relative to the body and to cease the operation of the motor when the magnet reaches a desired position.

21. A mechanism according to claim 20 wherein the control system includes one or more limit switches.

22. A mechanism according to claim 1 wherein the magnet is movable in a linear manner relative to the through hole of the body.

23. A mechanism according to claim 22, the mechanism further including a motor and a reciprocating motion mechanism arranged to move the magnet between the first and second positions.

24. A mechanism according to claim 1, wherein the actuation means includes an actuation member contactable by a closure.

25. A mechanism according to claim 24 wherein the actuation member is movable between a first position corresponding to the first position of the magnet relative to the body portions, and a second position corresponding to the second position of the magnet relative to the body portions.

26. A mechanism according to claim 25 wherein movement of the actuation member from the first position to the second position is resisted a resilient member.

27. A mechanism according to claim 25 wherein the actuation member is movable linearly between said first and second positions.

28. A mechanism according to claim 24 wherein the actuation means includes a drive member coupled to the magnet, the drive member being arranged to transmit movement of the actuation member to the magnet.

29. A mechanism according to claim 28 wherein the drive member is coupled to the magnet via an intermediate member.

30. A mechanism according to claim 28 wherein the drive member is movable between a first position corresponding to the first position of the magnet relative to the body portions, and a second position corresponding to the second position of the magnet relative to the body portions.

31. A mechanism according to claim 30 wherein movement of the drive member from the first position to the second position is resisted a resilient member.

32. A mechanism according to claim 30 wherein the drive member is rotatable between said first and second positions.

33. A mechanism according to claim 30 wherein the actuation means includes a latch arrangement operable to releasably retain the drive member in the second position.

34. A mechanism according to claim 33 wherein the latch arrangement includes a latch arm and a latch arm actuator.

35. A mechanism according to claim 24 wherein the actuation means includes a sensor operable to determine the position of the actuation member.

36. A method of controlling a closure retention and release mechanism, the method comprising the steps of:
providing a master controller having a transmitter;
providing a slave unit having a receiver;
providing a closure retention and release mechanism according to claim 1 associated with the slave unit, the slave unit being operable to switch the closure retention and release mechanism between closure retention and release states;
transmitting a control signal from the master controller to the slave unit; wherein the slave unit is operable to switch the state of the closure retention and release mechanism in the absence of receiving the control signal from the master controller.

37. A method according to claim 36 wherein the control signal is a repetitive signal.

38. A method according to claim 37 wherein the control signal comprises a series of pulses.

39. A method according to claim 38 wherein the slave unit is operable to switch the state of the closure retention and release mechanism in the absence of receiving one or more pulses of the control signal.

40. A method according to claim 36 wherein the slave unit is switchable between an active state wherein the slave unit is configured so as to receive the control signal, and an inactive state wherein the slave unit is not able to receive the control signal.

41. A method according to claim 40 wherein the switching of the slave unit from the active state to the inactive state is triggered by receipt of the control signal by the slave unit.

42. A method according to claim 40 wherein switching of the slave unit subsequently back to the active state occurs after a predetermined time period has elapsed after the slave unit has entered the inactive state.

43. A method according to claim 38 wherein the slave unit acts to switch the state of the closure retention and release mechanism in response to the absence of receiving a single pulse of the control signal.

44. A method according to claim 38 wherein the slave unit acts to switch the state of the closure retention and release mechanism after failing to receive a plurality of pulses of the control signal.

45. A method according to claim 44 wherein the slave unit enters an alert state after failing to receive a first pulse of the control signal whereupon the slave unit remains in the active state in anticipation of receiving a subsequent pulse of the control signal.

46. A method according to claim 36, the method including the additional step of;
incorporating a command into the control signal, the command prompting the slave unit to switch the state of the closure retention and release mechanism.

47. A method according to claim 36 wherein the method includes the additional steps of;
providing the slave unit with a transmitter;
providing the master controller with a receiver;
incorporating an interrogation command into the control signal;
sending the interrogation command to the slave unit to prompt the slave unit to respond to the master controller.

48. A control system for a closure retention and release mechanism according to claim 1, the control system comprising a master controller having a transmitter, a slave unit having a receiver, and a closure retention and release mechanism associated with the controller, the slave unit being operable to switch the closure retention and release mechanism between closure retention ad release states in the absence of receiving a control signal from the master controller.
